(19) United States
(12) Patent Application Publication
(10) Pub. No.: US 2023/0258213 A1
(43) Pub. Date: Aug. 17, 2023

(54) Method for Assembling a Mattress Foundation

(71) Applicant: WERNER MEDIA PARTNERS LLC, PLANTATION, FL (US)

(72) Inventor: Marc Werner, Plantation, FL (US)

(73) Assignee: WERNER MEDIA PARTNERS LLC, PLANTATION, FL (US)

(21) Appl. No.: 17/810,821

(22) Filed: Jul. 5, 2022

Related U.S. Application Data
(60) Provisional application No. 63/203,010, filed on Jul. 3, 2021.
(60) Provisional application No. 63/263,992, filed on Nov. 12, 2021.

(51) Int. Cl. F16B 12/56; A47C 19/02; A47C 19/12

(52) U.S. Cl. CPC F16B 12/56; A47C 19/027; A47C 19/12

(57) ABSTRACT

A method for assembling a mattress foundation is used with a disassembled mattress foundation that can fit within a package that qualifies for discount shipping. A mattress foundation provides support for a mattress. The mattress foundation can be disassembled to fit within a flat-rate shipping package. The mattress foundation includes reinforcements that add strength without adding weight above the flat-rate shipping requirements. A mounting plate allows the mattress foundation to be attached to a variety of headboards and footboards, even when the headboards and footboards use a different configuration of bolts to attach to the bedframe.

### CROSS-REFERENCE TO RELATED APPLICATIONS

This application claims the benefit of U.S. Provisional Application No. 63/203,010, filed Jul. 5, 2021, and U.S. Provisional Application No. 63/263,992, filed Nov. 12, 2021, both of which are incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to mattress foundations.

### Description of the Related Art

Freight shippers offer discounted shipping rates to complying packages. One such shipping standard FEDEX EXPRESS® U.S. services. With FEDEX EXPRESS® U.S. services, one can ship packages up to 68.0 kg; up to 302 cm in length and 419 cm in length and girth. With FEDEX EXPRESS® international services, one can ship packages up to 69.0 kg; up to 274 cm in length and 330 cm in length and girth. With FEDEX EXPRESS® Freight Services, you can ship individual skids of 68.0 kg or more. Skids exceeding 997.9 kg in weight or exceeding 178 cm in height, 302 in length, or 203 cm in width require prior approval. FEDEX FREIGHT® shipments may be palletized or nonpalletized, weigh up to 9072 kg, and measure up to 640 cm in length. With FEDEX GROUND® AND FEDEX HOME DELIVERY® Services, one can ship packages up to 68.0 kg; up to 274 cm in length, and 419 cm in length plus girth.

The length and girth formula is calculated using the following method.
Measure the length, height, and width of the package.
Length and girth equals length plus twice the width and twice the height.

Calculating Dimensional Weight Dimensional weight applies when the package is relatively light compared with its volume. If the dimensional weight exceeds the actual weight, charges based on the dimensional weight will be assessed. To calculate it:
Multiply length by width by height in inches.
Divide by 139 for U.S., Puerto Rico, and international shipments.
Compare the dimensional weight and actual weight.
The chargeable weight is the greater of the actual weight or the dimensional weight.

Mattresses are manufactured in standard sizes.
Twin.
Twin XL
Full
Queen
King
California King
Split King.

A problem with mattress foundations used with foam mattresses is “weeping”. Weeping occurs as a foam mattress oozes (i.e., sags, settles, or stretches) between the slats, especially over time. Narrowing the space between slats by increasing the size of the slats or the number of slats increases the weight of the mattress foundation. In addition, a solid mattress foundation prevents moisture (e.g., perspiration) from escaping a foam mattress.

In the assembly of a bed, a headboard is connected to a bed frame. The headboard is typically bought separately from the bed frame. No standard exists for the layout of screws for the mounting of bedframes to headboards. One brand or model of headboard might have a different set of holes and screws than another brand or model. One brand or model of bedframe might have a different set of holes and screws than another brand or model. A first sized headboard (e.g., king size, queen size, etc.) might have holes and screws that do not match a second sized headboard. A first sized bedframe might have holes and screws that do not match a second sized bedframe. Ultimately, if a purchaser of a mattress and mattress foundation cannot be attached to the purchaser's headboard, the purchaser will return the mattress foundation and mattress.

Mattress owners have different needs and tastes in bed height. Some owners prefer a low “European” style bed. Others prefer lots of clearance for storage between a mattress foundation and the floor. If a mattress foundation has a height that does not fulfill a potential purchaser's preferences or needs, the potential purchaser will not buy the foundation.

### BRIEF SUMMARY OF THE INVENTION

An object of the invention is to provide a mattress foundation that overcomes the disadvantages of the devices and methods of this general type and of the prior art.

With the foregoing and other objects in view there is provided, in accordance with the invention, a mattress foundation that can be shipped unassembled in a package that qualifies for discounted shipping.

A further object of the invention is to provide a mattress foundation that reduces weeping of a foam mattress between slats of the mattress foundation. To prevent weeping, the horizontal (i.e., left to right) slats on a left side of the mattress foundation are not aligned with the horizontal slats on a right side of the mattress foundation. A mattress foundation having a number of unaligned horizontal slats has less weeping than a mattress foundation having the same number of aligned horizontal slats. Generally, spacing slats approximately eighteen centimeters (˜18 cm) apart in an unaligned configuration will prevent weeping. For areas of the mattress foundation that underly the torso of a sleeper, spacing the slats closer (i.e., approximately nine centimeters (˜9 cm)).

A further object of the invention is to provide a center-post leg that will not bend under the combined weight and motion of two people. When a flange is attached to the center of a bedframe and a center post is screwed into the flange, the flange has been found to be a weak point that will be the first point to fail. To make a stronger connection with the center post, the center post can be screwed directly into a center, vertical (i.e., front to back) slat. By inserting the center post directly into the slat, no torque is created.

A further object of the invention is to provide a mounting plate that can interconnect a mattress foundation to as many configurations and sizes of headboards as possible. Such a mounting plate can have a shape that allows the mounting plate to be mounted in one direction (i.e., vertically or “portrait”) and in another direction (i.e., horizontally or “landscape”) depending on the combination of mattress frame hole and bolt configuration and headboard hole and bolt configuration. The mounting plate can be rectangular. The mounting plate can include various slots through which bolts can be inserted. The mounting plate can include at least one horizontal slot and at least one vertical slot. The mounting plate can include a top horizontal slot, a bottom horizontal slot, and at least one vertical slot between the top and bottom horizontal slots.

A further object of the invention is to provide a mattress foundation with an adjustable height. Each leg can be formed by a plurality of stackable leg segments. Each leg would have the same number of leg segments and each respective leg segment in each leg would have an equal height. The bottom segment can include a footer to protect the floor and/or to prevent the bed from moving. The leg segments can screw into the leg segment above it. The top leg segment screws into the mattress foundation frame. If a higher bed is preferred, all of the leg segments can be used to form the legs. If a medium bed is preferred, two leg segments can be used to form each leg. If a low bed is preferred, only one leg segment can be used to form each leg. For a twin-sized or smaller mattress foundation, six legs can be utilized: one at each corner and one on the left vertical frame and one on the right vertical frame. For a full-sized or larger mattress foundation, nine legs can be utilized: one at each corner, one at the middle of the left vertical frame, one at the middle of the right vertical frame, and three along the center vertical span (front, middle, rear).

Other features that are considered as characteristic for the invention are set forth in the appended claims.

Although the invention is illustrated and described herein as embodied in mattress foundation, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a top left perspective view of an assembled mattress foundation and a box for shipping an unassembled mattress foundation according to the invention.

FIG. 2 is a top left perspective view of the assembled mattress foundation shown in FIG. 1.

FIG. 3 is a front, bottom, left perspective view of the box shown in FIG. 1.

FIG. 4 is a top rear perspective view of a left side vertical support, right side vertical support, central vertical support, and front horizontal support, each in an unfolded position.

FIG. 5 is a top rear right perspective view of the left side vertical support and the front horizontal support shown in FIG. 4 shown attached to each other.

FIG. 6 is a top elevational view of the central vertical support joined to two slats.

FIG. 7 is a top elevational view of the central vertical support joined to slats and bundled horizontal slats.

FIG. 8 is a top front elevational view of the central vertical support shown in FIG. 7.

FIG. 9 is a top, rear, right perspective view of the left side vertical support joined to the rear horizontal support with a cover shown in a draped position.

FIG. 10 is a top, rear, right perspective view of a headboard plate being attached to the rear horizontal support shown in FIG. 9.

FIG. 11 is a top rear perspective view of the headboard plate shown in FIG. 10.

FIG. 12 is a top left perspective view of an assembled mattress foundation with first leg segments installed.

FIG. 13 is a top left perspective view of the assembled mattress foundation shown in FIG. 12 with the first segments and second leg segments installed.

FIG. 14 is a top left perspective view of the assembled mattress foundation shown in FIG. 12 with the first segments, the second leg segments, and third leg segments installed.

FIG. 15 is a front perspective view of an unassembled mattress foundation.

FIG. 16 is a left top perspective view of a king-size mattress foundation with a cover installed over the frame and a box for shipping the mattress foundation.

FIG. 17 is a left rear top perspective view of the mattress foundation shown in FIG. 16 with the cover retracted from a front left corner of the frame.

FIG. 18 is a left rear top perspective view of the mattress foundation shown in FIG. 16 with the first and second leg segments installed.

FIG. 19 is a left top perspective view of a twin-size mattress foundation with a cover partially installed over the frame and a box for shipping the mattress foundation.

FIG. 20 is a partial, left rear top perspective view of the twin-size mattress foundation shown in FIG. 19, with the first and second leg segments installed.

FIG. 21 is a side elevational view of four legs.

FIG. 22 is a table listing dimensions of mattress foundation sizes and respective packaging sizes.

FIG. 23 is a partial rear elevational view of the mattress frame shown in FIG. 9 with the mounting plate in a horizontal position.

FIG. 24 is a partial rear elevational view of the mattress frame shown in FIG. 9 with the mounting plate in a vertical position.

FIG. 25 is a perspective view of a threaded T-nut.

FIG. 26 is a partial top right perspective view of the left vertical support shown in FIG. 4 with a hinge in a locked position.

FIG. 27 is a side elevational view of rails.

FIG. 28 is a partial side elevation view of the rails shown in FIG. 27.

FIG. 29 is a perspective view of a slat separated from a rail.

FIG. 30 is a side elevational view of a leg with two leg segments.

FIG. 31 is an exploded perspective view of the leg shown in FIG. 30.

FIG. 32 is a front top right perspective view of a mattress frame.

FIG. 33 is a partial rear bottom right perspective view of the mattress frame shown in FIG. 32.

FIG. 34 is a bottom perspective view of a cover.

FIG. 35 is a top elevational view of a second embodiment of a mounting plate.

FIG. 36 is a right elevational view of the mounting plate shown in FIG. 35.

FIG. 37 is a rear elevational view of the mounting plate shown in FIG. 35.

FIG. 38 is a left elevational view of the mounting plate shown in FIG. 35.

FIG. 39 is a top front left perspective view of the mounting plate shown in FIG. 35.

FIG. 40 is a front elevational view of the mounting plate shown in FIG. 35.

FIG. 41 is a bottom elevational view of the mounting plate shown in FIG. 35.

### DETAILED DESCRIPTION OF THE INVENTION

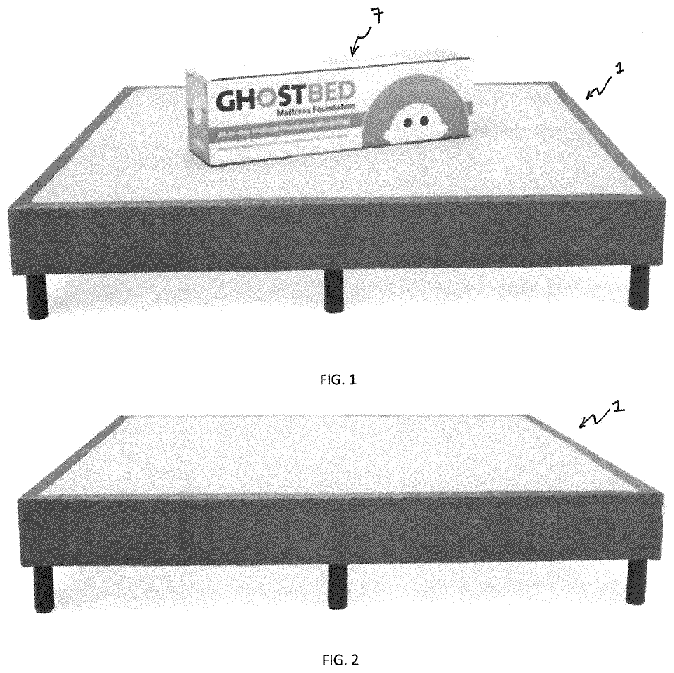

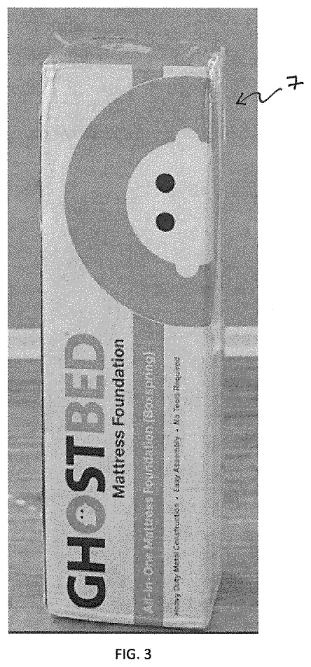

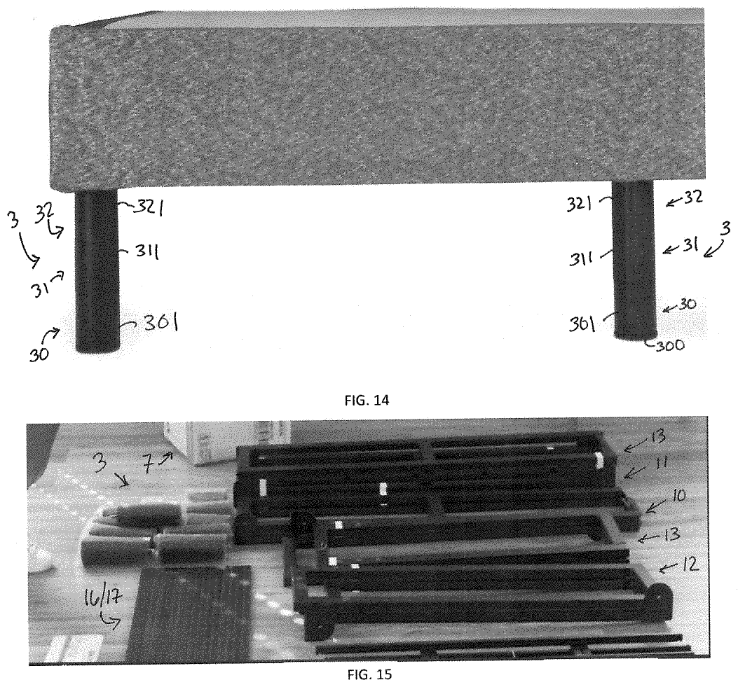

FIGS. 1-21 show a preferred embodiment of a mattress foundation and the steps of a method for assembling the mattress foundation.

In a first step, a left side vertical support 10 is unfolded and placed on a floor. A right side vertical support 11 is unfolded and placed parallel to the left side vertical support 10. A central vertical support 18 is unfolded and placed between the left side vertical support 10 and the right side vertical support 11. The word “vertical” is meant to mean longitudinal: i.e., running from front to back. The left side vertical support 10 has a front support 100. The right side vertical support 11 has a front support 110. A front horizontal support 12 is shown unfolded. “Horizontal” is mean to mean latitudinal; i.e., running from left to right. The front horizontal support 12 has a left support piece 120 and a right support piece 121.

FIG. 5 shows a next step. The front horizontal support 12 is shown being connected to the left side vertical support 11. The front support 100 is placed against the left support piece 120. A threaded socket 1200 is formed in the left support piece. A hole 1003 is formed in the front support 100. A bolt, which is not shown, is to be inserted through the hole 1003 and screwed into the threaded socket 1200. Similarly, the central vertical support 18 and the right side vertical support 11 are joined to the front horizontal support 12. A rear horizontal support 13 is joined to the left vertical support 10, the right vertical support 11, and the central vertical support 18.

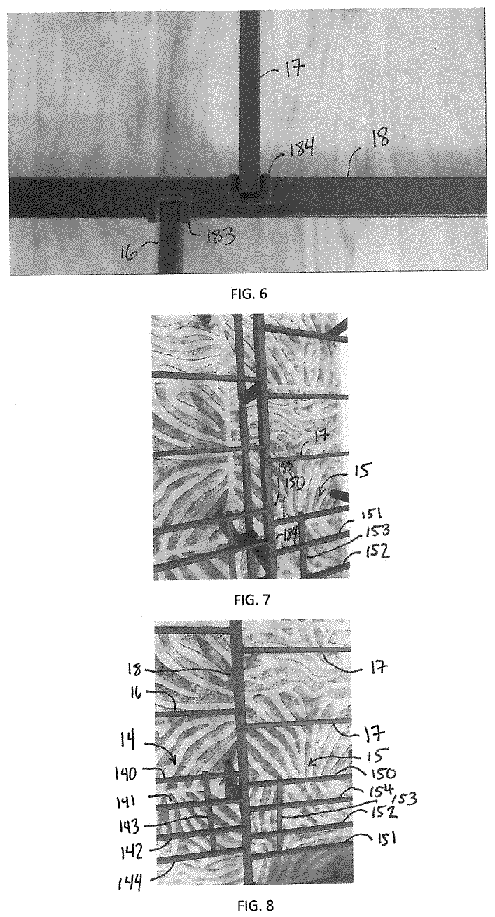

FIG. 6 shows the central vertical support 18. The central vertical support 18 has a resinous left seat 183 and right seat 184. A left slat 16 is held in the left seat 183. A right slat 17 is held in the right seat 184. The left seat 183 and the right seat 184 are at a different height along the central vertical support 18. A preferred spacing between adjacent left slats 16 and adjacent right slats 17 is eighteen centimeters (18 cm).

FIGS. 7-8 show a left bundled slat 14 and a right bundled slat 15. The left bundled slat 14 includes four horizontal slats 140, 141, 142, 143. A left vertical slat 144 supports the four horizontal slats 140, 141, 142, 143. The right bundled slat 15 includes four horizontal slats 150, 151, 152, 153. A right vertical slat 154 supports the four horizontal slats 150, 151, 152, 153. A preferred spacing between adjacent horizontal slats 140, 141, 142, 143 in a left bundled slat 14 and the four horizontal slats 150, 151, 152, 153 in the right bundled slat 15 is eight and nine-tenths centimeters (8.9 cm).

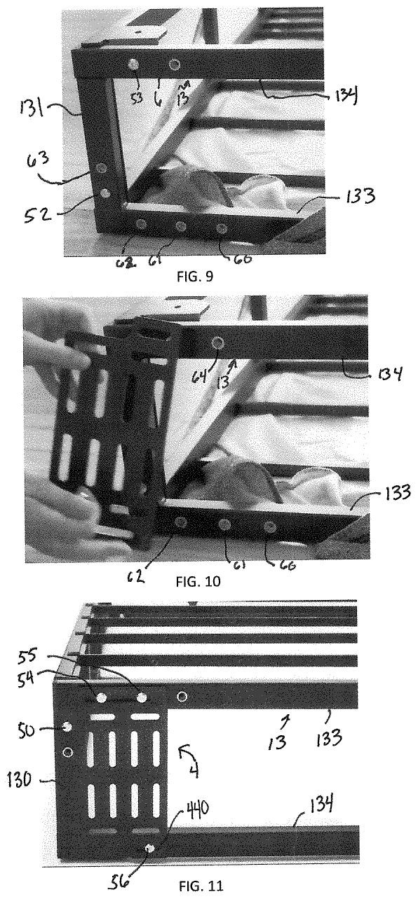

FIGS. 9-11 show a rear horizontal support 13. The rear horizontal support 13 includes a right support piece 131, top support piece 133, and bottom support piece 134. Bolts 50, 52, and 53 fasten the rear horizontal support 13 to the right side vertical support 11. Threaded sockets 60, 61, 62 are disposed in the top support piece 133. Threaded socket 63 is formed in the right support piece 131. Threaded socket 64 is disposed in the bottom support piece 134.

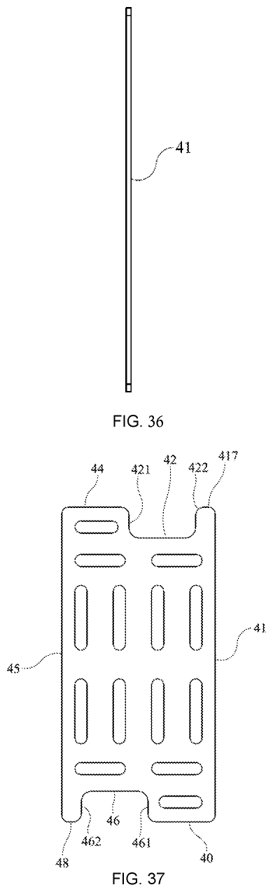

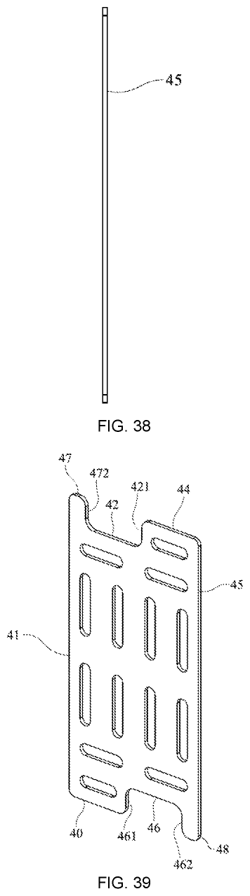

FIGS. 10-11 further show a mounting plate 4 being attached to the rear horizontal support 13. As explained in conjunction with FIGS. 35-41, the mounting plate 4 is placed with an outer third-edge slot 440 overlying threaded socket 64 and with outer first-edge slot 400 overlying threaded sockets 61 and 62. Bolts 54, 55, and 56 are inserted through the slots 400 and 440 and screwed into the 62, 61, and 64, respectively.

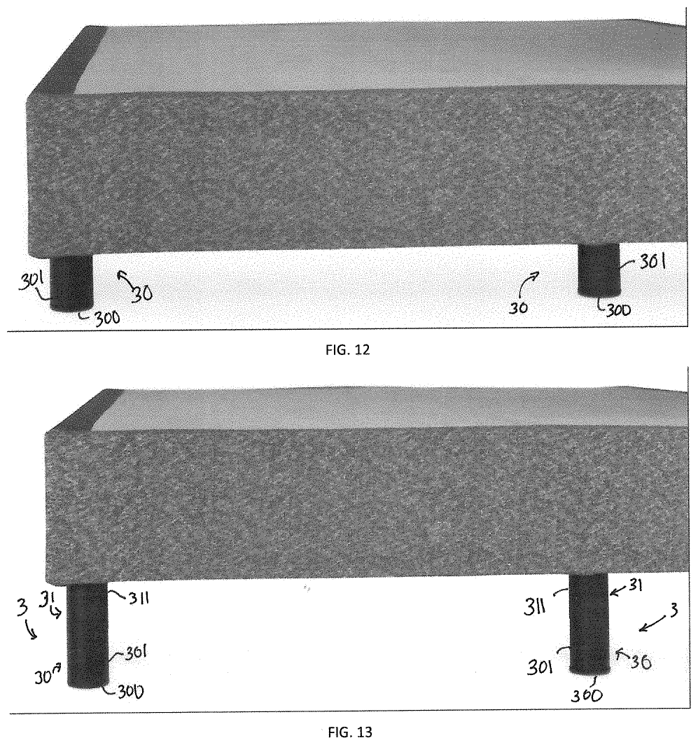

FIGS. 12-14 show a mattress foundation with different height legs 3. In FIG. 12, each leg 3 includes a first leg segment 30. The first leg segment 30 includes a foot 300, a cylindrical body 301, and a bolt (which is not visible in FIG. 12).

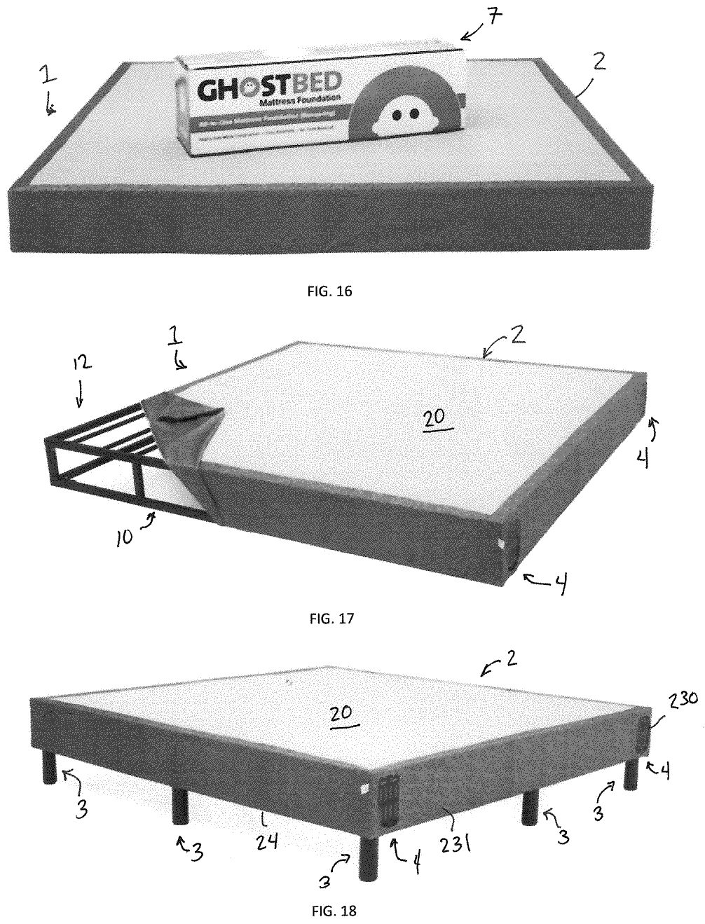

FIG. 16 shows an unassembled mattress foundation. The left side vertical support 10, the right side vertical support 11, and the central vertical support 18 are shown in a folded position. The front horizontal support 12 and the rear horizontal support 13 are shown in a folded position. A plurality of legs 3 are shown. Left slats 16 and right slats 17 are shown. All of these parts fit within box 7.

FIG. 16 shows an assembled frame 1 with a cover 2. A box 7 is shown.

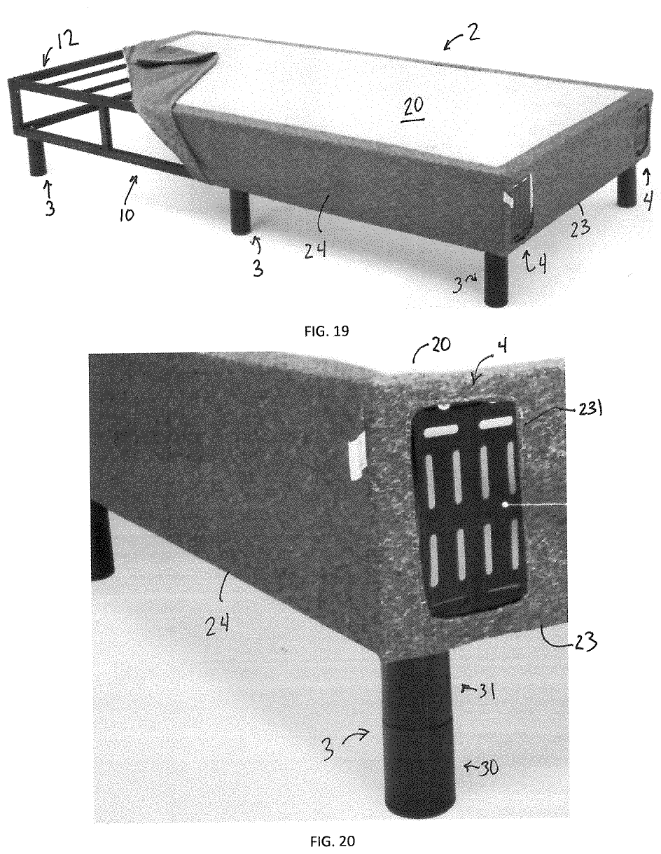

FIGS. 17-18 show a king-sized mattress foundation. FIG. 19 shows a twin-sized mattress foundation. A cover 2 is placed over the left vertical support 10 and the front horizontal support 12. The cover 2 includes a top 20, a rear 23, and a left 24. The rear 23 has a right rear opening 230 and a left rear opening 231 formed therein. The right rear opening 230 and the left rear opening 231 provide access to the mounting plates 4. FIG. 20 shows a cover 20 that includes a rear 23 and left 24. The rear 23 has a left rear opening 231 formed therein that provides access to the mounting plate 4. A leg 3 is shown with first leg segment 30 and second leg segment 31.

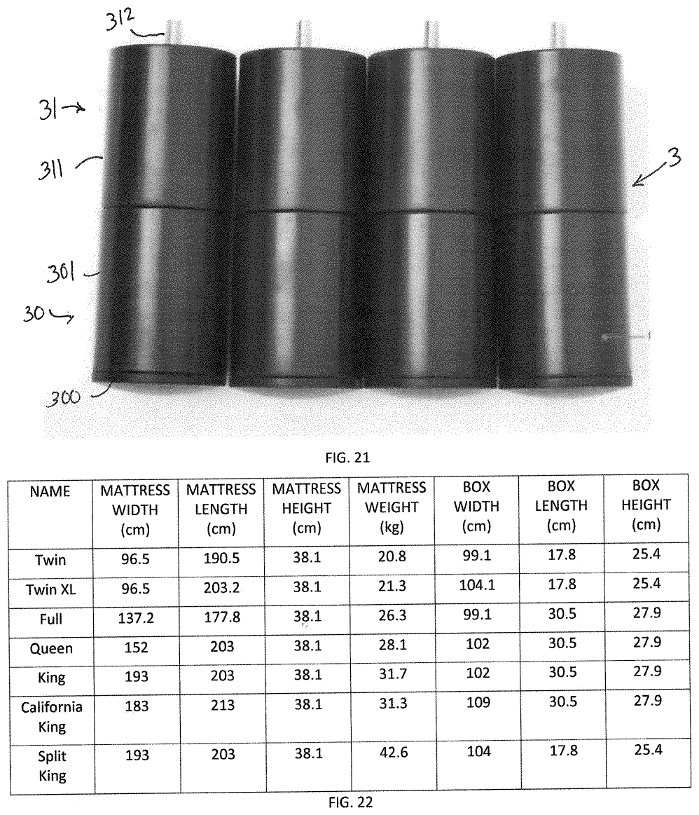

FIG. 21 shows legs 3 that include first segment 30 and second segment 31. The first segment 30 includes a foot 300 and a body 301. The second segment 31 includes a body 311 and a bolt 312.

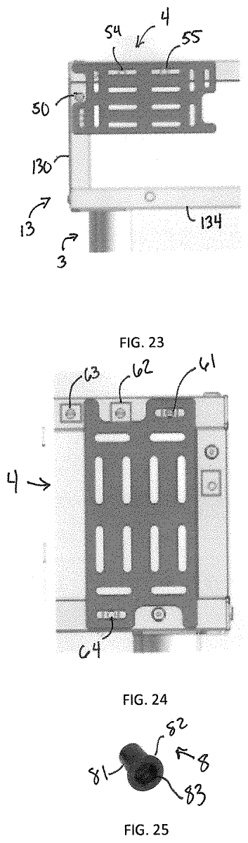

FIG. 23 shows a mounting plate 4 secured to a rear horizontal support 13. Bolt 54 and bolt 55 are inserted through slots in the mounting plate 4. The mounting plate 4 is oriented in a landscape position with the larger dimension being horizontal and the shorter dimension being vertical.

FIG. 24 shows the mounting plate 4 secured to a rear horizontal support 13. Bolts 61 and 64 are inserted through slots in the mounting plate 4. The mounting plate is in a portrait position, with the larger dimension being vertical, and the smaller dimension being horizontal. The cutout avoids interference with the threaded socket 62.

FIG. 25 shows an inner-threaded bolt 8. The inner-threaded bolt 8 has a head 80 and a cylindrical body 81. A threaded bore 82 is formed axially through the head 80 and the cylindrical body 81.

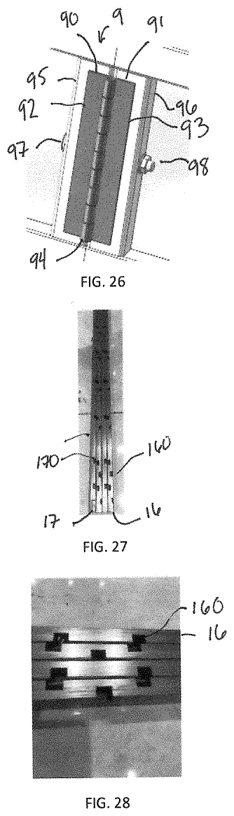

FIG. 26 shows a hinge 9. The hinge 9 includes a first leaf 90 and a second leaf 91. A plurality of hinges 92 and 93 alternate along the length of the hinge 9. A hinge pin 94 is inserted through the hinges 92 and 93. The first leaf 90 is welded to frame support 95. The second leaf 91 is welded to the frame support 96. When the hinge 9 is open, a cotter bolt 97 is driven through the frame support 95 and frame support 96. A lock nut 98 secures the cotter bolt 97.

FIG. 27-28 show left slats 16 and right slats 17. The left stats 16 and the right stats 17 are extruded, hollow rectangular tubes. The slats have a plurality of rectangular notches 160 and 170 formed therein.

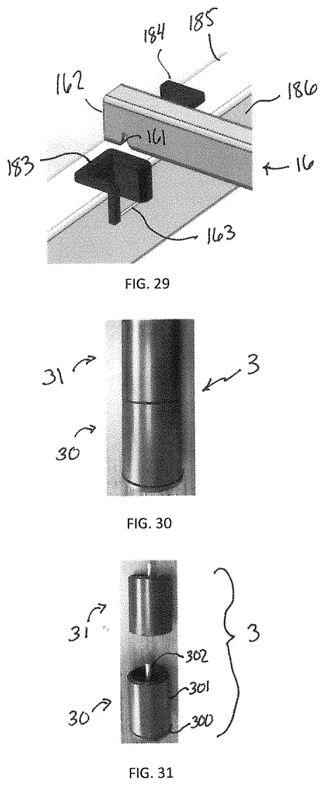

FIG. 29 shows a top support piece 185 of a central vertical support 18. A left seat 183 and a right seat 184 are held in a form locking connection within rectangular notches in the vertical support 18. The left seat 183 and the right seat 184 are made from a resin. A left slat 16 has an endpiece 162 that rests in the left seat 183. The left slat 16 has a notch 161 that defines the endpiece 162. The notch 161 receives a cutout edge 163. The sides of the notch 161 are arcuate.

FIGS. 30-31 show a leg 3. The leg 3 includes a first leg segment 30 and a second leg segment 31. The first leg segment 30 has a rubber foot 300, a cylindrical body 301, and a bolt extending vertically from the cylindrical body 301.

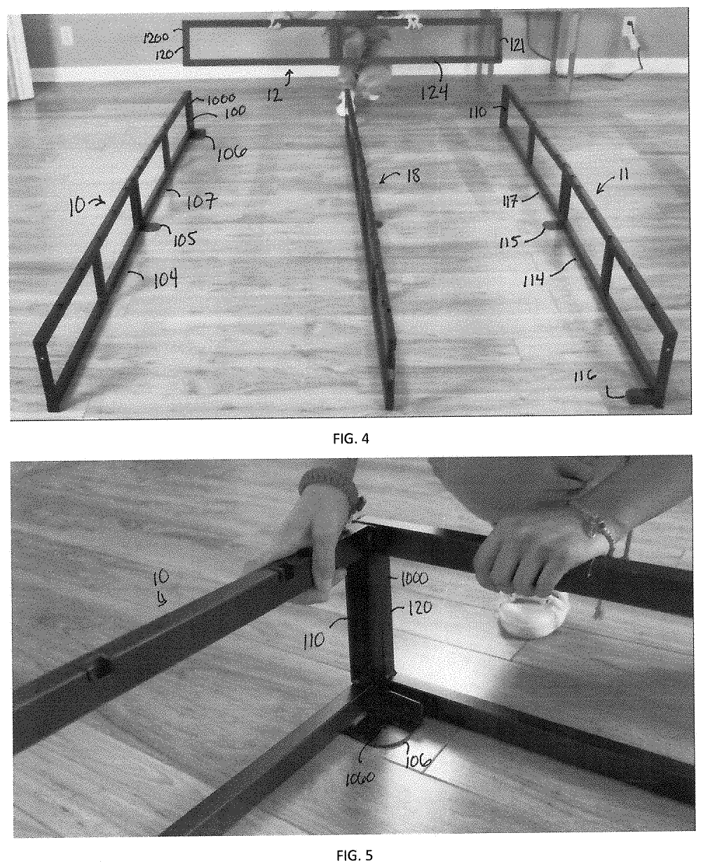

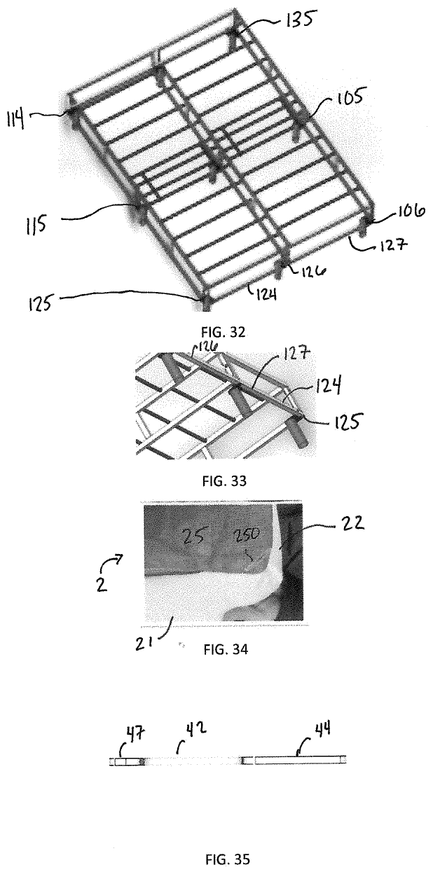

FIGS. 32-33 show an assembled bedframe 1. See also FIG. 4. A rear left flange 135 is connected to the bottom support piece 134. A middle left flange 105 is connected to the bottom support piece 104. A front left flange 106 is connected to the bottom support piece 107. A front right flange 125 is connected to the bottom support piece 124. A front middle flange 127 is connected to the bottom support piece 126. The middle right flange 115 is connected to the bottom support piece 117. The rear right flange 116 is connected to the bottom support piece 114. Each flange 105, 106, 115, 116, 125, 127, and 135 is horizontal (i.e., parallel to the ground) and extends inward. A threaded hole is drilled in 1050, 1060, 1150, 1250, and 1350 is formed in each respective flange 105, 106, 115, 116, 125, and 135.

FIG. 34 shows a preferred embodiment of a cover 2. The cover has a front 21, a right 22, and a bottom 25. The bottom has a reinforced opening 250. The reinforced opening 250 is centered 2.5 cm from the front 21 and right 22 so the opening overlies the threaded hole 1250 in the front right flange 125. After the frame 1 is assembled but before the legs 3 are attached, the cover 2 is placed over the frame 1. The bolt 322 of the leg 3 is fed through the reinforced opening 250 and screwed into the threaded hole 1250.

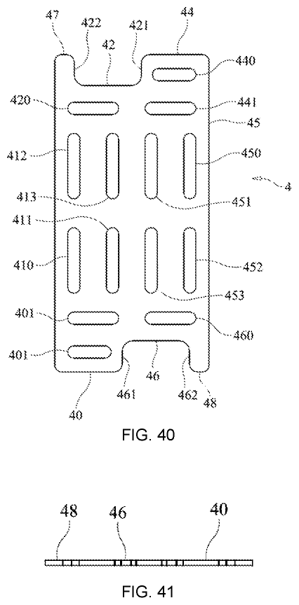

FIGS. 35-41 show a second preferred embodiment of a mounting plate 4. The mounting plate is preferably made of steel and has a generally (except for the recessed segments 42 and 46) rectangular shape. FIG. 40 shows a perimeter of the mounting plate 4, which includes a first edge segment 40, which connects to a second edge 41, which connects to a third edge tab segment 47, which connects to a lateral third-edge-recess wall 422, which connects to a recessed third edge segment 42, which connects to a medial third-edge-recess wall 421, which connects to a third edge segment 44, which connects to a fourth edge segment 45, which connects to a first edge tab segment 48, which connects to a lateral first-edge-recess wall 462, which connects to a first edge recessed segment 46, which connects to a medial first-edge-recess wall, which connects to the first edge segment 40. The mounting plate 4 has the following discorectangular (also referred to as stadium-shaped) slots formed therein: outer first-edge slot 400, inner first-edge slot 401, first-edge-side outer second-edge slot 410, first-edge-side inner second-edge slot 411, third-edge-side outer second-edge slot 412, third-edge-side inner second-edge slot 413, recessed-third-edge slot 420, outer third-edge slot 440, inner third-edge slot 441, third-edge-side outer fourth-edge slot 450, third-edge-side inner fourth-edge slot 451, first-edge-side outer fourth-edge slot 452, first-edge-side inner fourth-edge slot 453, and recessed-first-edge slot 460.

What is claimed is:

1. A method for assembling a mattress foundation, which comprises:
unfolding a left side vertical support, said left side vertical support having a front support piece, a rear support piece, and a left-side hinge interconnecting said front support piece, and said rear support piece;
unfolding a right side vertical support, said right side vertical support having a front support piece, a rear support piece, and a right-side hinge interconnecting said front support piece, and said rear support piece;
placing said front horizontal support against said front support piece of said left side vertical support;
placing said front horizontal support against said front support piece of said right side vertical support;
placing said rear horizontal support against said rear support piece of said left side vertical support;
placing said rear horizontal support against said rear support piece of said right side vertical support;
attaching said front section of said left side vertical support to said front horizontal support;
attaching said front section of said right side vertical support to said front horizontal support;
attaching said rear section of said left side vertical support to said rear horizontal support; and
attaching said rear section of said right side vertical support to said rear horizontal support.

2. The method according to claim 1, which further comprises:
forming a bundle slat receptacle in said front support piece;
providing a bundled slat, said bundled slat having a front bundled horizontal slat, a rear bundled horizontal slat, and a vertical slat interconnecting said first horizontal slat and said second horizontal slat; and
disposing said front bundled horizontal slat in said bundle slat receptacle of said front support piece of said left side vertical piece.

3. The method according to claim 1, which further comprises placing said left side vertical support to be parallel to said right side vertical support.

4. The method according to claim 1, which further comprises facing said left-side hinge facing to right-side hinge.

5. The method according to claim 1, which further comprises, before placing said front horizontal support, unfolding a front horizontal support, said front horizontal support having a left support piece, a right support piece, and a front hinge interconnecting said left support piece and said right support piece.

6. The method according to claim 5, which further comprises, before placing said rear horizontal support, unfolding a rear horizontal support, said rear horizontal support having a left support piece, a right support piece, and a rear hinge interconnecting said left support piece and said right support piece.

7. The method according to claim 2, wherein said bundled slat, said bundled slat having a front bundled horizontal slat, a rear bundled horizontal slat, and a vertical slat interconnecting said first horizontal slat and said second horizontal slat.

8. The method according to claim 1, which further comprises:
providing a cover, said cover having a right wall, a left wall, a front wall, a rear wall, and a bottom rim connected to said right wall, said left wall, front wall, and rear wall;
placing said front wall of said cover over said front horizontal support;
placing said rear wall of said cover over said rear horizontal support;
placing said right wall of said cover over said right vertical support; and
placing said left wall of said cover over said left vertical support.

9. The method according to claim 8,
providing a first leg segment, said first leg segment having a top, a bolt extending from said top; and a bottom having a threaded socket formed therein;
screwing said bolt of said first leg segment through said bottom rim of said cover into said threaded socket of said front support piece of said left vertical support;
providing a second leg segment, said second leg segment having a top, and a bolt extending from said top; and
screwing said bolt of said second leg segment into said threaded socket of said first leg segment.

10. The method according to claim 1, further comprising:
unfolding a central vertical support, said central vertical support having a front support piece, a rear support piece, and a central hinge interconnecting said front support piece and said rear support piece;
attaching said front support piece of said central vertical support to said front horizontal support; and
attaching said rear support piece of said central vertical support to said rear horizontal support.

11. The method according to claim 10, which further comprises placing said central vertical support to be parallel to and between said right side vertical support and said left side vertical support.

12. The method according to claim 1, further comprising bracing at least one of said left hinge and said right hinge.
